(19) United States
(12) Patent Application Publication
(10) Pub. No.: US 2013/0251246 A1
(43) Pub. Date: Sep. 26, 2013

(54) METHOD AND A DEVICE FOR TRAINING A POSE CLASSIFIER AND AN OBJECT CLASSIFIER, A METHOD AND A DEVICE FOR OBJECT DETECTION

(71) Applicant: NEC (CHINA) CO., LTD., Beijing (CN)

(72) Inventors: Shaopeng Tang, Beijing (CN); Feng Wang, Beijing (CN); Guoyi Liu, Beijing (CN); Hongming Zhang, Beijing (CN); Wei Zeng, Beijing (CN)

(73) Assignee: NEC (China) Co., Ltd., Beijing (CN)

(21) Appl. No.: 13/743,010

(22) Filed: Jan. 16, 2013

(30) Foreign Application Priority Data
Mar. 21, 2012 (CN) CN201210077224.3

(51) Int. Cl. G06K 9/62

(52) U.S. Cl. CPC G06K 9/6267
USPC 382/159

(57) ABSTRACT

A method and a device for training a pose classifier and an object classifier, and a method and a device for objection detection, relating to the field of image processing are provided. The object detection method includes acquiring input image samples; performing pose estimation processing on said input image sample according to said pose classifier; and performing object detection on the processed input image sample according to said pose classifier to acquire the location information of the object, wherein said object is an object with joints. Objects in different poses can be detected and therefore the object hit rate is increased.

### TECHNICAL FIELD

The present invention relates to the field of the image processing, and more particularly, to a method and a device for the training a pose classifier and an object classifier, and a method and a device for object detection.

### BACKGROUND OF THE INVENTION

Along with the development of electronic information technology and the popularization of networking, people are increasingly acquiring a large amount of image and video data by various image collecting devices such as monitoring video cameras, digital video cameras, web cameras, digital cameras, phone cameras, and video sensors in the Internet of Things during daily life. In response to such huge amount of image and video data, how to quickly and intelligently analyze all the data has become an urgent need.

Human body detection technology is one of the technical approaches to intelligently analyze the data. Referring to FIG. 1, for an input image, the process of human body detection is to detect human bodies in the image, locate the human bodies and output the locations of the human bodies as the detection result.

The existing methods for human body detection are mainly classified into three types:

The first type is a method based on local feature extraction. By this type of method, features are computed based on the sub-areas of the training image; the features of different sub-areas are permutated and combined together in a certain way as the features of a human body; and then the classifier is trained according to the features of the human body. During the detection process, the features of the corresponding sub-areas of the input image are detected and computed, and then the classifier classifies the computed features to realize the human body detection.

The second type is a method based on interest points. By this type of method, firstly, computing the interest points based on a training image set, then extracting blocks centered on the points with a certain dimension, clustering all the extracted blocks to generate a dictionary. During the detection process, the identical interest points in the input image are computed, and blocks are extracted, then similar blocks are searched from the dictionary, finally the location of the human body in the input image is identified by voting according to the blocks in the dictionary to realize the human body detection.

The third type is a method based on template matching. By this type of method, templates of body contours are prepared in advance. During the detection process, the edge distribution images of an input image are computed, and areas most similar to the body contours are searched from the edge distribution images to realize human body detection.

During the process of realizing the present invention, the inventor finds at least the following problems in the prior art: the above three types of method can realize human body detection to a certain extent, but they all generally assume that the human body is upright and ignore the pose variation of the human body as a flexible object. When the pose of the human body varies, the existing human body detection methods can hardly distinguish the human body from the background area, therefore the human body hit rate is reduced.

### BRIEF SUMMARY OF THE INVENTION

To improve the human hit rate, a method and a device for training a pose classifier and an object classifier, and a method and a device for object detection are provided in the embodiments of the present invention. The technical solutions are as follows:

One objective of the embodiments of the present invention is to provide a method for the training a pose classifier, comprising:

acquiring a first training image sample set;

acquiring the actual pose information of a specified number of training image samples in said first training image sample set;

executing a regression training process according to said specified number of training image samples and the actual pose information thereof to generate a pose classifier.

In one embodiment, said executing a regression training process according to said specified number of training image samples and the actual pose information thereof to generate a pose classifier comprises:

constructing a loss function, wherein the input of said loss function is said specified number of training image samples and the actual pose information thereof, the output of said loss function is the difference between the actual pose information and the estimated pose information of said specified number of training image samples;

constructing a mapping function, wherein the input of said mapping function is said specified number of training image samples, the output of said mapping function is the estimated pose information of said specified number of training image samples;

executing regression according to said specified number of training image samples and the actual pose information thereof, selecting the mapping function which minimizes the output value of said loss function as the pose classifier.

Wherein, preferably, said loss function is the location difference between the actual pose information and the estimated pose information.

Wherein, preferably, said loss function is the location difference and direction difference between the actual pose information and the estimated pose information.

One objective of the embodiments of the present invention is to provide a method for training an object classifier using the pose classifier generated by the method according to the above mentioned method, said objects is an object with joints, said method comprises:

acquiring a second training image sample set;

performing pose estimation processing on a specified number of training image samples in said second training image sample set according to said pose classifier;

executing training on the training image samples processed with said pose estimation to generate an object classifier.

In one embodiment, said performing pose estimation processing on a specified number of training image samples in said second training image sample set according to said pose classifier comprises:

performing pose estimation on a specified number of training image samples in said second training image sample set according to said pose classifier to obtain the estimated pose information of said specified number of training image samples;

constructing a plurality of training object bounding boxes for each object with joints according to the estimated pose information of said specified number of training image samples, performing normalization on said plurality of training object bounding boxes such that the training object bounding boxes of the same part of different objects are consistent in size and direction;

said executing training on the training image samples processed with said pose estimation comprises:

executing training on said normalized training image samples.

In another embodiment, after said obtaining the estimated pose information of said specified number of training image samples, further comprises:

displaying the estimated pose information of said specified number of training image samples.

In another embodiment, after said performing normalization on said plurality of training object bounding boxes, further comprises:

displaying said plurality of normalized training object bounding boxes.

In another embodiment, said estimated pose information specifically is the location information of the structural features of the training object, said structural features points of training object comprise:

a head central point, waist central point, left foot central point, and right foot central point;

said constructing a plurality of object bounding boxes for each object with joints according to the estimated pose information of said specified number of training image samples, performing normalization on said plurality of object bounding boxes comprises:

constructing three object bounding boxes for each object with joints by respectively taking the straight line between the head central point and the waist central point as the central axis, the straight line between the waist central point and the left foot central point as the central axis, and the straight line between the waist central point and the right foot central point as the central axis, rotating and resizing said three object bounding boxes; wherein said structural feature points of object are located in the corresponding object bounding boxes.

In another embodiment, said estimated pose information specifically is the location information of the structural feature points of training object, said structural feature points of training object comprise:

a head central point, waist central point, left knee central point, right knee central point, left foot central point, and right foot central point;

said constructing a plurality of object bounding boxes for each object with joints according to the estimated pose information of said specified number of training image samples, performing normalization on said plurality of training object bounding boxes comprises:

constructing five object bounding boxes for each object with joints by respectively taking the straight line between the head central point and the waist central point as the central axis, the straight line between the waist central point and the left knee central point as the central axis, the straight line between the waist central point and the right knee central point as the central axis, the straight line between the waist central point and the left foot central point as the central axis, and the straight line between the waist central point and the right foot central point as the central axis, rotating and resizing said five object bounding boxes; wherein said structural feature points of object are located in the corresponding object bounding boxes.

Another objective of the embodiments of the present invention is to provide a method for object detection using the pose classifier generated by the above mentioned method and the object classifier generated by the above mentioned method, said object is an object with joints, said method comprises:

acquiring input image samples;

performing pose estimation processing on said input image samples according to said pose classifier;

performing object detection on the processed input image samples according to said object classifier to acquire the location information of the object.

In one embodiment, said performing pose estimation processing on said input image samples according to said pose classifier comprises:

performing pose estimation on said input image samples according to said pose classifier to obtain the estimated pose information of said input image samples;

constructing a plurality of object bounding boxes for each object with joints according to the estimated pose information of said input image samples, performing normalization on said plurality of object bounding boxes such that the object bounding boxes of the same part of different objects are consistent in size and direction;

correspondingly, said performing object detection on the processed input image samples according to said object classifier comprises:

performing object detection on said normalized input image samples according to said object classifier.

In another embodiment, after said obtaining the estimated pose information of said input image samples, further comprises:

displaying the estimated pose information of said input image samples.

In another embodiment, after said performing normalization on the plurality of object bounding boxes, further comprises:

displaying said plurality of normalized object bounding boxes.

In another embodiment, said estimated pose information specifically is the location information of the structural feature points of object, said structural feature points of object comprise:

a head central point, waist central point, left foot central point, and right foot central point;

said constructing a plurality of object bounding boxes for each object with joints according to the estimated pose information of said input image samples, performing normalization on said plurality of object bounding boxes comprises:

constructing three object bounding boxes for each object with joints by respectively taking the straight line between the head central point and the waist central point as the central axis, the straight line between the waist central point and the left foot central point as the central axis, and the straight line between the waist central point and the right foot central point as the central axis, rotating and resizing said three object bounding boxes; wherein said structural feature points of object are located in the corresponding object bounding boxes.

In another embodiment, said estimated pose information specifically is the location information of the structural feature points of object, said structural feature points of object comprise:

a head central point, waist central point, left knee central point, right knee central point, left foot central point, and right foot central point;

said constructing a plurality of object bounding boxes for each object with joints according to the estimated pose information of said input image samples, performing normalization on said plurality of object bounding boxes comprises:

constructing five object bounding boxes for each object with joints by respectively taking the straight line between the head central point and the waist central point as the central axis, the straight line between the waist central point and the left knee central point as the central axis, the straight line between the waist central point and the right knee central point as the central axis, the straight line between the waist central point and the left foot central point as the central axis, and the straight line between the waist central point and the right foot central point as the central axis, rotating and resizing said five object bounding boxes; wherein said structural feature points of said object are located in the corresponding object bounding boxes.

Another objective of the embodiments of the present invention is to provide a device for training a pose classifier, comprising:

a first acquisition module for acquiring a first training image sample set;

a second acquisition module for acquiring the actual pose information of a specified number of training image samples in said first training image sample set;

a first training generation module for executing a regression training process according to said specified number of training image samples and the actual pose information thereof to generate a pose classifier.

In one embodiment, said first training generation module comprises:

a first construction unit for constructing a loss function, wherein the input of said loss function is said specified number of training image samples and the actual pose information thereof, the output of said loss function is a difference between the actual pose information and the estimated pose information of said specified number of training image samples;

a second construction unit for constructing a mapping function, wherein the input of said mapping function is said specified number of training image samples, the output of said mapping function is the estimated pose information of said specified number of training image samples;

a pose classifier acquisition unit for executing regression according to said specified number of training image samples and the actual pose information thereof, selecting the mapping function which minimizes the output value of said loss function as the pose classifier.

Wherein, preferably, said loss function is the location difference between the actual pose information and the estimated pose information.

Wherein, preferably, said loss function is the location difference and direction difference between the actual pose information and the estimated pose information.

Another objective of the embodiments of the present invention is to provide a device for training an object classifier using the pose classifier generated by the above mentioned device, said object is an object with joints, said device comprises:

a third acquisition module for acquiring a second training image sample set;

a first pose estimation module for performing pose estimation processing on a specified number of training image samples in said second training image sample set according to said pose classifier;

a second training generation module for executing training on the training image samples processed with said pose estimation to generate an object classifier.

In one embodiment, said first pose estimation module comprises:

a first pose estimation unit for performing pose estimation on a specified number of training image samples in said second training image sample set according to said pose classifier to obtain the estimated pose information of said specified number of training image samples;

a first construction processing unit for constructing a plurality of training object bounding boxes for each object with joints according to the estimated pose information of said specified number of training image samples, performing normalization on said plurality of training object bounding boxes such that the training object bounding boxes of the same part of different objects are consistent in size and direction;

said second training generation module comprises:

a training unit for executing training on said normalized training image samples.

In another embodiment, said device further comprises:

a first graphic user interface for displaying the estimated pose information of said specified number of training image samples after said obtaining the estimated pose information of said specified number of training image samples.

In another embodiment, said device further comprises:

a second graphic user interface for displaying said plurality of normalized training object bounding boxes after said performing normalization on said plurality of training object bounding boxes.

In another embodiment, said estimated pose information specifically is the location information of the structural feature points of training object, said structural feature points of training object comprise:

a head central point, waist central point, left foot central point, and right foot central point;

said first construction processing unit comprises:

a first construction sub-unit for constructing three object bounding boxes for each object with joints by respectively taking the straight line between the head central point and the waist central point as the central axis, the straight line between the waist central point and the left foot central point as the central axis, and the straight line between the waist central point and the right foot central point as the central axis, rotating and resizing said three object bounding boxes; wherein said structural feature points of object are located in the corresponding object bounding boxes.

In another embodiment, said estimated pose information specifically is the location information of the structural feature points of training object, said structural feature points of training object comprise:

a head central point, waist central point, left knee central point, right knee central point, left foot central point, and right foot central point;

said first construction processing unit comprises:

a second construction sub-unit for constructing five object bounding boxes for each object with joints by respectively taking the straight line between the head central point and the waist central point as the central axis, the straight line between the waist central point and the left knee central point as the central axis, the straight line between the waist central point and the right knee central point as the central axis, the straight line between the waist central point and the left foot central point as the central axis, and the straight line between the waist central point and the right foot central point as the central axis, rotating and resizing said five object bounding boxes; wherein said structural feature points of object are located in the corresponding object bounding boxes.

Another objective of the embodiments of the present invention is to provide a device for object detection using the pose classifier generated by the above mentioned device and the object classifier generated by the above mentioned device, said object is an object with joints, said device comprises:

a fourth acquisition module for acquiring input image samples;

a second pose estimation module for performing pose estimation processing on said input image samples according to said pose classifier;

and a detection module for performing objects detection on the processed input image samples according to said object classifier to acquire the location information of the object.

In one embodiment, said second pose estimation module comprises:

a second pose estimation unit for performing pose estimation on said input image samples according to said pose classifier to obtain the estimated pose information of said input image samples;

a second construction processing unit for constructing a plurality of object bounding boxes for each object with joints according to the estimated pose information of said input image samples, performing normalization on said plurality of object bounding boxes such that the training object bounding boxes of the same part of different objects are consistent in size and direction;

said detection module comprises:

a detection unit for performing object detection on said normalized input image samples according to said object classifier.

In another embodiment, said device further comprises:

a third graphic user interface for displaying the estimated pose information of said input image samples after said obtaining the estimated pose information of said input image samples.

In another embodiment, said device further comprises:

a fourth graphic user interface for displaying said plurality of normalized object bounding boxes after said performing normalization on the plurality of object bounding boxes.

In another embodiment, said estimated pose information specifically is the location information of the structural feature points of an object, said structural feature points of an object comprise:

a head central point, waist central point, left foot central point, and right foot central point;

said second construction processing unit comprises:

a third construction sub-unit for constructing three object bounding boxes for each object with joints by respectively taking the straight line between the head central point and the waist central point as the central axis, the straight line between the waist central point and the left foot central point as the central axis, and the straight line between the waist central point and the right foot central point as the central axis, rotating and resizing said three object bounding boxes; wherein said structural feature points of object are located in the corresponding object bounding boxes.

In another embodiment, said estimated pose information specifically is the location information of the structural feature points of an object, said structural feature points of an object comprise:

a head central point, waist central point, left knee central point, right knee central point, left foot central point, and right foot central point;

said second construction processing unit comprises:

a fourth construction sub-unit for constructing five object bounding boxes for each object with joints by taking the straight line between the head central point and the waist central point as the central axis, the straight line between the waist central point and the left knee central point as the central axis, the straight line between the waist central point and the right knee central point as the central axis, the straight line between the waist central point and the left foot central point as the central axis, and the straight line between the waist central point and the right foot central point as the central axis, rotating and resizing said five object bounding boxes; wherein said structural feature points of said object are located in the corresponding object bounding boxes.

The technical solutions provided by the embodiments of the present invention have the following benefits: the pose classifier is generated by training the specified number of training image samples in the first training image set using a regression method, then pose estimation is performed in the processes of object classifier training and object detection using said pose classifier, object bounding boxes are further constructed and normalized, therefore the impact of the pose on the calculation of object features are eliminated such that the same type of objects can have consistent feature vectors even in different poses, thereby objects with joints in different poses can be detected and object hit rate can be increased.

In addition, the pose classifier generated by the regression method is output to the object classifier training process and the object detection process respectively for pose estimation, and computation complexity of the method in the present embodiment is reduced compared with that of traditional pose estimation methods.

Preferably, a direction difference is considered in constructing loss function, therefore it is more advantageous for detecting objects in different poses, and the object hit rate is increased.

The methods and devices provided in the present invention can be applied to the field of image or video analysis such as human body counting, or the field of video surveillance etc.

### BRIEF DESCRIPTION OF THE SEVERAL VIEWS OF THE DRAWINGS

The present invention will become more fully understood from the accompanying drawings as below. However, these drawings are only exemplary. Still further variations can be readily obtained by one skilled in the art without burdensome and/or undue experimentation. Such variations are not to be regarded as a departure from the spirit and scope of the invention.

FIG. 1 shows a flow chart of an embodiment of a method for training a pose classifier provided in the embodiments of the present invention.

FIG. 2 shows a flow chart of another embodiment of the method for training a pose classifier provided in the embodiments of the present invention.

FIG. 3 shows a schematic diagram of extracting the feature vectors of the training image samples provided in the embodiments in the present invention.

FIG. 4 shows a schematic diagram of an estimated location provided in the embodiments of the present invention.

FIG. 5 shows a flow chart of an embodiment of a method for training an object classifier provided in the embodiments of the present invention.

FIG. 6 shows a flow chart of another embodiment of the method for training an object classifier provided in the embodiments of the present invention.

FIG. 7 shows a schematic diagram of object bounding boxes of four feature points provided in the embodiments in the present invention.

FIG. 8 shows a schematic diagram of object bounding boxes of six feature points provided in the embodiments in the present invention.

FIG. 9 shows a flow chart of an embodiment of a method for object detection provided in the embodiments of the present invention.

FIG. 10 shows a flow chart of another embodiment of the method for object detection provided in the embodiments of the present invention.

FIG. 11 shows a schematic diagram of ROC curves of the embodiment of the present invention and an existing embodiment provided in the embodiments of the present invention.

FIG. 12 shows a structural diagram of an embodiment of a device for training a pose classifier provided in the embodiments of the present invention.

FIG. 13 shows a structural diagram of another embodiment of the device for training a pose classifier provided in the embodiments of the present invention.

FIG. 14 shows a structural diagram of an embodiment of a device for training an object classifier provided in the embodiments of the present invention.

FIG. 15 shows a structural diagram of another embodiment of the device for training an object classifier provided in the embodiments of the present invention.

FIG. 16 shows a structural diagram of an embodiment of a device for object detection provided in the embodiments of the present invention.

FIG. 17 shows a structural diagram of another embodiment of the device for object detection provided in the embodiments of the present invention.

### DETAILED DESCRIPTION OF THE INVENTION

To clarify the objectives, technical solutions, and advantages of the present invention, the embodiments of the present invention are further described in detail with the reference to the attached drawings in the followings.

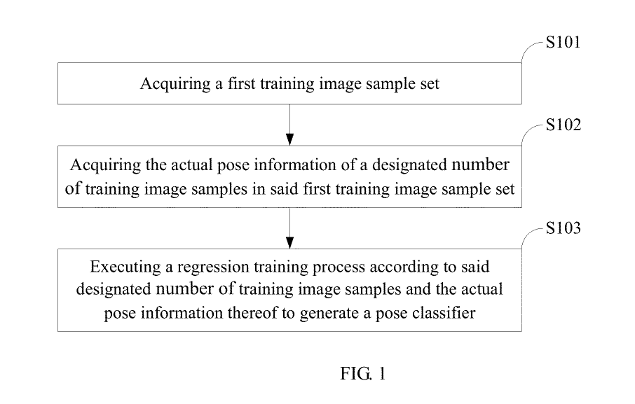

Referring to FIG. 1, a flow chart of an embodiment of a method for training a pose classifier is provided in the embodiment of the present invention. Said method for training a pose classifier comprises:

S101: Acquiring a first training image sample set.

S102: Acquiring the actual pose information of a specified number of training image samples in said first training image sample set.

S103: Executing a regression training process according to said specified number of training image samples and the actual pose information thereof to generate a pose classifier.

In the present embodiment, the pose classifier is generated by acquiring a first training image sample set and the actual pose information of a specified number of training image samples in said first training image sample set, and executing a regression training process according to said specified number of training image samples and the actual pose information thereof, such that objects in different poses can be detected by the pose classifier, thereby the object hit rate is increased.

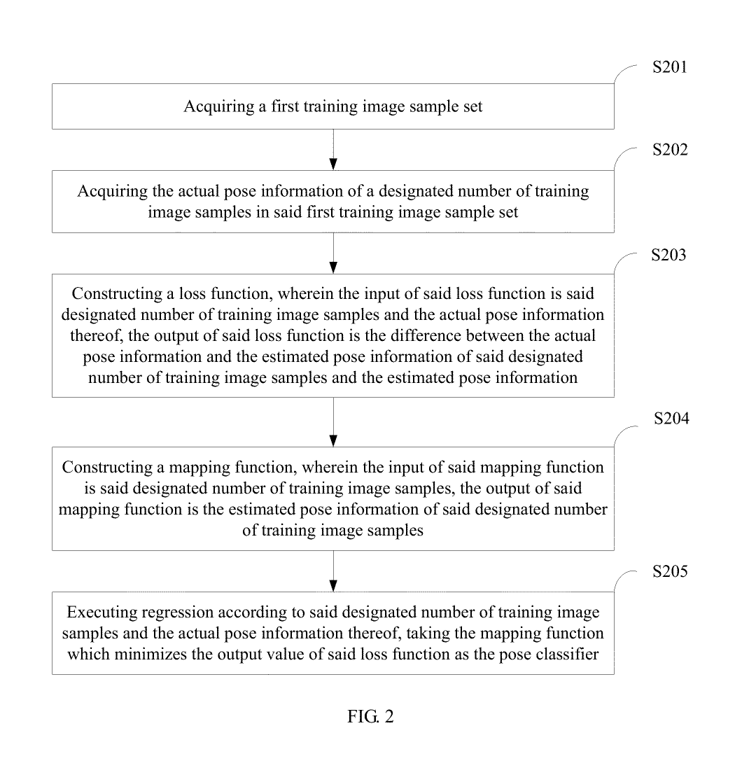

The objects in the embodiment of the present invention are specifically objects with joints, including but not limited to objects such as human bodies, robots, monkeys or dogs, etc. In the present embodiment, human bodies are used as an example for detailed description. Referring to FIG. 2, a flow chart of another embodiment of the method for training a pose classifier is provided in the embodiment of the present invention.

Said method for training a pose classifier comprises:

S201: Acquiring a first training image sample set.

During the process of training the pose classifier, a plurality of image samples shall be used as training image samples to execute the training process. Specifically, said plurality of image samples can be pieces of images of objects with joints, such as human bodies or other objects. In the embodiment of the present invention, the plurality of training image samples can be stored as a first training image sample set.

All the training image samples in said first training image sample set can be acquired by image collecting device(s) at the same scene, or different scenes. Preferably, in the embodiment of the present invention, image samples of human bodies in various poses shall be selected as much as possible and stored in said first training image sample set as training image samples, thus the accuracy of the generated pose classifier is improved.

S202: Acquiring the actual pose information of a specified number of training image samples in said first training image sample set.

In the embodiment of the present invention, the related actual pose information refers to the location information of each part of human body, such as the location information of the head or the waist, etc. The location information of each part of human body may represent the specific location of each part of the human body. Said specified number of training image samples can be all the training image samples in said first training image sample set, or part of the training image samples in said first training image sample set. Preferably, said specified number of training image samples refer to all the training image samples in said first training image sample set, such that the accuracy of the generated pose classifier is improved.

In this step, the human bodies in said specified number of training image samples shall be manually marked to obtain the actual pose information of the human bodies in said specified number of training image samples.

Specifically, each part of the human body can be represented by structural feature points of the human body, said structural feature points of the human body refer to the points capable of reflecting the human body structure. There may be one or more structural feature points of the human body. Preferably, there may be four or six structural feature points of the human body. In the case that there are four structural feature points of the human body, said structural feature points of the human body comprise: a head central point, a waist central point, a left foot central point, and a right foot central point; in the case that there are six structural feature points of human body, said structural feature points of the human body comprise: a head central point, a waist central point, a left knee central point, a right knee central point, a left foot central point, and a right foot central point. However, the number of the structural feature points of the human body is not limited to four or six, and will not be described in detail here.

S203: Constructing a loss function, wherein the input of said loss function is said specified number of training image samples and the actual pose information thereof, and the output of said loss function is the difference between the actual pose information and the estimated pose information of said specified number of training image samples.

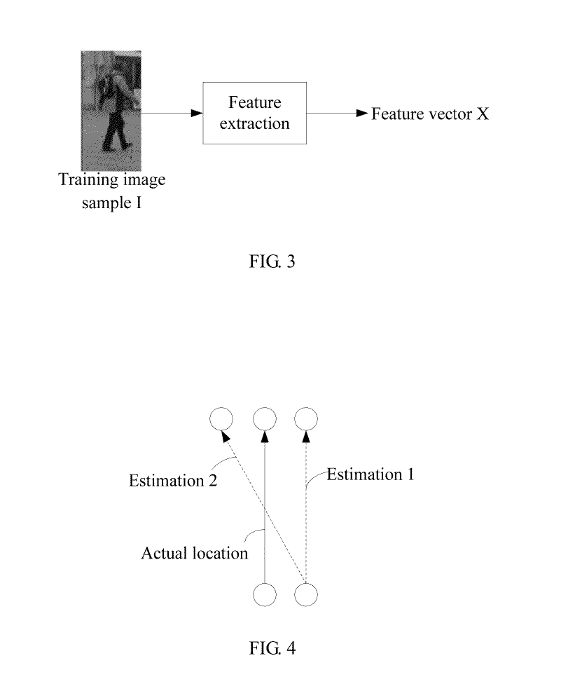

In the embodiment of the present invention, the input of the loss function includes said specified number of training image samples, specifically the feature vectors of said specified number of training image samples. Referring to FIG. 3, a schematic diagram of extracting the feature vectors of the training image samples is provided in the embodiments of the present invention. Providing that the training image sample is I and its feature vector is X, the feature vector X is obtained by extracting features from the training image sample I. Wherein the feature vector X of the training image sample may describe the mode information of the object, such as the color, grayscale, texture, gradient and shape of the image, etc.; in the video, said feature vector X of the training image sample may also describe the motion information of the object.

Preferably, said feature vector of the training image sample is a HOG feature. Wherein, a HOG feature is a feature describer for detecting objects in computer vision and image processing. The method of extracting the HOG feature uses the oriented gradient feature of the image itself, and it is a method of computing on grid units with dense meshes and uniform dimensions, finally concatenating the features of different meshes as the feature of the training image sample, and further adopting the method of overlapping local contrast normalization to improve the precision. The method of extracting the HOG feature is similar to the methods in the prior art and therefore will not be described in detail here. Refer to the related descriptions in the prior art for details.

Said loss function may have many forms, for example, said loss function is the location difference between the actual pose information and the estimated pose information, including:

$${J}^{′} ( y , F ( x ) ) = {\sum }_{i = 1}^{N} ψ ( {y}_{i} , F ( {x}_{i} ) ) = {\sum }_{i = 1}^{N} {‖ {y}_{i} - F ( {x}_{i} ) ‖}^{2} ,$$

wherein J′(y,F(x)) represents the loss function; F(x) represents the mapping function; y represents the actual pose information of said specified number of training image samples; ψ(yᵢ,F(xᵢ)) represents the mapping function of the i^{th} training image sample; yᵢ represents the actual pose information of the i^{th} training image sample; xᵢ represents the i^{th} training image sample; F(xᵢ) represents the mapping function of the i^{th} training image sample; and N represents the total number of the training image samples.

The loss function J′(y,F(x)) is not limited to the above mentioned expression form, and will not be described in detail here. All loss functions capable of reflecting the location difference between the actual pose information and the estimated pose information shall belong to the protection scope of the present invention.

In another embodiment, preferably, said loss function is the location difference and direction difference between the actual pose information and the estimated pose information, including:

$$J ( y , F ( x ) ) = {\sum }_{i = 1}^{N} {\sum }_{j = 2}^{q} \{ {‖ {y}_{i , 1} - g ( {x}_{i} ) ‖}^{2} + α {‖ ( {y}_{i , j} - {y}_{i , 1} ) - ( {F}_{j} ( {x}_{i} ) - g ( {x}_{i} ) ) ‖}^{2} \} ,$$

wherein J(y,F(x)) represents the loss function; y represents the actual pose information of said specified number of training image samples; F(x) represents the mapping function; y_{i,1} represents the actual location of the root node in the i^{th} training image sample; g(xᵢ) represents the estimated location of the root node in the i^{th} training image sample; y_{i,j} represents the actual location of the j^{th} structural feature point of human body in the i^{th} training image sample; Fⱼ(xᵢ) represents the mapping function of the j^{th} structural feature point of human body in the i^{th} training image sample; N represents the total number of the training image samples; and q represents the total number of the structural feature points of human body, α is a weighing coefficient, 0<α<1.

In the loss function J(y,F(x)), taking the waist central point as the root node, an axis is constructed as the axis of the actual pose information according to the waist central point and other structural feature points of the human body, then the direction difference between said actual pose information and said estimated pose information can be represented by the vector between the axis of said actual pose information and the axis of the corresponding estimated pose information. For example,

$${\sum }_{i = 1}^{N} {\sum }_{j = 2}^{q} \{ α {‖ ( {y}_{i , j} - {y}_{i , 1} ) - ( {F}_{j} ( {x}_{i} ) - g ( {x}_{i} ) ) ‖}^{2} \} ;$$

the direction difference can also be represented by the included angle between the axis of the actual pose information and the axis of the estimated pose information, which will not be described in detail here.

Said loss function J(y,F(x)) is not limited to the above mentioned expression form, and will not be described in detail here. All loss functions capable of reflecting the location difference and direction difference between the actual pose information and the estimated pose information shall belong to the protection scope of the present invention.

Referring to FIG. 4, the schematic diagram of the estimated location is provided in the embodiment of the present invention. For the loss function J(y,F(x)), the estimated location (Estimation 2) is more effective than the estimated location (Estimation 1) in the FIG. 4 because the direction of the estimated location 2 is consistent with that of the actual position, and this is more effective for the feature extraction. Therefore, it is advantageous for the detection of the human body in different poses to take the location difference and direction difference between the actual pose information and the estimated pose information into consideration when loss function is constructed.

S204: Constructing a mapping function, wherein the input of said mapping function is said specified number of training image samples, the output of said mapping function is the estimated pose information of said specified number of training image samples.

In this step, firstly, the weak mapping function which minimizes the output value of said loss function is selected from a preset weak mapping function pool, said weak mapping function is used as the initial mapping function, and a mapping function is constructed according to said initial mapping function.

The weak mapping function pool in the embodiment of the present invention is a pool containing a plurality of weak mapping functions. The weak mapping functions in said weak mapping function pool are constructed according to experience. Preferably, said weak mapping function pool contains 3,025 weak mapping functions. Wherein each weak mapping function corresponds to a sub-window, then preferably, said weak mapping function pool in the embodiment of present invention contains 3,025 sub-windows.

It is known from the expression formula of the loss function, said loss function is a function of the mapping function F(x); said loss function is respectively substituted by each of the weak mapping functions in said weak mapping function pool; the output value of said loss function is computed according to said specified number of training image samples and the actual pose information; the weak mapping function which minimizes the output value of said loss function is obtained; and the weak mapping function which minimizes the output value of said loss function is used as the initial mapping function F₀(x).

The mapping function F(x) is constructed according to the initial mapping function F₀(x), for example

$$F ( x ) = {F}_{0} ( x ) + {\sum }_{t = 1}^{T} {λ}_{t} {h}_{t} ( x ) ,$$

wherein the input of said mapping function F(x) is said specified number of training image samples; the output of said mapping function is the estimated pose information of said specified number of training image samples; λₜ represents the optimal weight of the t^{th} regression; hₜ(x) represents the optimal weak mapping function of the t^{th} regression; and T represents the total times of regression.

S205: Executing regression according to said specified number of training image samples and the actual pose information thereof, selecting the mapping function which minimizes the output value of said loss function as the pose classifier.

In an embodiment of the present invention, the process of solving F(x) is a process of regression. Each time the regression is carried out, the optimal weak mapping function hₜ(x) is selected from the weak mapping function pool according to the preset formula; the optimal weight of the current regression λₜ is computed according to said hₜ(x) to obtain the mapping function F(x) of the current regression; along with the successive regressions, the output value of the loss function corresponding to the mapping function is reduced successively; when the obtained mapping function F(x) is converged, regression stops and at this moment the output value of said loss function corresponding to the mapping function F(x) is minimal; and the mapping function which minimizes the output value of said loss function is used as the pose classifier.

The process of judging if the mapping function is converged specifically includes: providing that the mapping function F(x) obtained by the T^{th} regression is converged, the output value of the loss function corresponding to the mapping function F(x) obtained by the T^{th} regression is computed as φ_{T}; the output value of the loss function corresponding to the mapping function F(x) obtained by the (T−1)^{th} regression is computed as φ_{T-1}; then 0≦φ_{T-1}−φ_{T}≦a preset threshold value, wherein the preset threshold value may be but not limited to 0.01.

The loss function represents the degree of the difference between the actual pose information and the estimated pose information (namely the mapping function). In the present embodiment, said loss function can be used to calculate the pose classifier, which means that the mapping function corresponding to the minimal value of the loss function is used as the pose classifier, which also means that the pose classifier is the estimated pose information mostly close to the actual pose information.

The calculation process for acquiring the pose classifier is described using the loss function J(y,F(x)) as an example.

For a single training image sample, the loss function is:

$$ψ = {\sum }_{j = 1}^{j = q} \{ {‖ {P}_{root , j} - {P}_{root , j}^{′} ‖}^{2} + α {‖ ( {P}_{j} - {P}_{root , j} ) - ( {P}_{j}^{′} - {P}_{root , j}^{′} ) ‖}^{2} \}$$

wherein q represents the total number of the structural feature points of human body; Pⱼ represents the actual location of the i^{th} structural feature point of human body; Pⱼ′ represents the estimated location of the j^{th} structural feature point of human body; P_{root,j} represents the actual location of the root note of Pⱼ, wherein said root note preferably is the waist central point; P_{root,j}′ represents the estimated location of the root node of Pⱼ; and (P_{root,j′} Pⱼ) represents the axis of the actual pose information.

For the whole first training image sample set, the loss function is:

$$\begin{matrix}J ( y , F ( x ) ) = {\sum }_{i = 1}^{N} ψ \\ = {\sum }_{i = 1}^{N} {\sum }_{j = 2}^{q} \{ {‖ {y}_{i , 1} - g ( {x}_{i} ) ‖}^{2} + α {‖ ( {y}_{i , j} - {y}_{i , 1} ) - ( {F}_{j} ( {x}_{i} ) - g ( {x}_{i} ) ) ‖}^{2} \} \\ = {\sum }_{i = 1}^{N} {\sum }_{j = 2}^{q} {‖ {y}_{i , 1} - g ( {x}_{i} ) ‖}^{2} + {\sum }_{i = 1}^{N} {\sum }_{j = 2}^{q} α {‖ ( {y}_{i , j} - {y}_{i , 1} ) - ( {F}_{j} ( {x}_{i} ) - g ( {x}_{i} ) ) ‖}^{2} \\ = q {\sum }_{i = 1}^{N} {‖ {y}_{i , 1} - g ( {x}_{i} ) ‖}^{2} + α {\sum }_{i = 1}^{N} {\sum }_{j = 2}^{q} {‖ ( {y}_{i , j} - {y}_{i , 1} ) - ( {F}_{j} ( {x}_{i} ) - g ( {x}_{i} ) ) ‖}^{2} \\ = q {\sum }_{i = 1}^{N} {‖ {y}_{i , 1} - g ( {x}_{i} ) ‖}^{2} + α {\sum }_{i = 1}^{N} {\sum }_{j = 2}^{q} {‖ {u}_{i , j} - {k}_{j} ( {x}_{i} ) ‖}^{2} \\ = q {\sum }_{i = 1}^{N} {‖ {y}_{i , 1} - g ( {x}_{i} ) ‖}^{2} + α {\sum }_{i = 1}^{N} {‖ {u}_{i} - k ( {x}_{i} ) ‖}^{2} \\ = M ( k ( x ) )\end{matrix}$$

Said J(y,F(x)) is the loss function of all the training image samples in said first training image sample set. When J(y,F(x)) is constructed, the starting point of the axis of all the human body bounding boxes are defined as the same feature point, and said same feature point is defined as the root node; preferably, said root node is the waist central point, so the starting point of j in the loss function J(y,F(x)) is 2, excluding the root node.

wherein, kⱼ(xᵢ)=Fⱼ(xᵢ)−g(xᵢ)′u_{i,j}=y_{i,j}−y_{i,1},

For the above mentioned J(y,F(x)), F(x) can be obtained by computing k(x) and g(x)

g(x) can be solved by adopting the method of SVR (Support Vector Regression) and PCA (Principal Component Analysis), specifically the process comprises:

1a) input: {yᵢ,xᵢ}₁^{N},yᵢεR^{2q},xᵢεR^{d}

2a) compute rᵢ=p(y_{i,j}): R²→R¹, solving by PCA;

3a) compute W by minimizing

$$\frac{1}{2} {‖ w ‖}^{2} + C {\sum }_{n = 1}^{N} {\vert {r}_{i} - {g}^{′} ( {x}_{i} ) \vert}_{ξ} ,$$

wherein g′(x)=Σₙ₌₁^{N}wₙk(x,xₙ),k(x,xₙ) is a kernel function;

4a) output: g(x)=p⁻¹(g′(x)): R^{d}→R²;

wherein, R represents the field of real numbers; xᵢ represents the i^{th} training image sample; yᵢ represents the location of the j^{th} structural feature point of human body; rᵢ represents the location of the root node of the i^{th} training image sample; y_{i,1} represents the actual location of the root node in the i^{th} training image sample; w is a vector, representing the coefficient of the formula, for example if z=ax+by, then w=(a,b); C is a scale factor; N represents the total number of the training image samples; g′(xᵢ) represents the estimated location of the root node in the i^{tj} training image sample; and ξ represents the truncation coefficient.

k(x) can be computed by boosting method, specifically the method comprises:

1b) input: {yᵢ,xᵢ}₁^{N},yᵢεR^{2q},xᵢεR^{d};

2b) compute uᵢ={(y_{i,j}−y_{i,1})}ⱼ₌₂^{q}εR^{2q-2};

3b) set k(x)=0;

4b) loop: t:1→T, compute kₜ(x)=λₜhₜ(x), k(x)=k(x)+kₜ(x), check the convergence of k(x), and when k(x) is converged, the loop ends, wherein λₜ represents the optimal weight of the t^{th} regression; hₜ(x) represents the optimal weak mapping function of the t^{th} regression; and T represents the total number of regressions.

wherein,

$${λ}_{i} = \frac{{\sum }_{i = 1}^{N} ( {u}_{i} - k ( {x}_{i} ) ) {( h ( {x}_{i} ) )}^{T}}{{\sum }_{i = 1}^{N} {‖ h ( {x}_{i} ) ‖}^{2}} , \\ \begin{matrix}{h}_{i} = {argmax}_{h} \{ α \frac{{( {\sum }_{i = 1}^{N} ( {u}_{i} - k ( {x}_{i} ) ) {( h ( {x}_{i} ) )}^{T} )}^{2}}{( {\sum }_{i = 1}^{N} {‖ h ( {x}_{i} ) ‖}^{2} )} \frac{1}{\begin{matrix}α {\sum }_{i = 1}^{N} {‖ {u}_{i} - k ( {x}_{i} ) ‖}^{2} + \\ q {\sum }_{i = 1}^{N} {‖ {y}_{i , 1} - g ( {x}_{i} ) ‖}^{2}\end{matrix}} \} \\ = {argmax}_{h} \frac{\vert {\sum }_{i = 1}^{N} ( {u}_{i} - k ( {x}_{i} ) ) {( h ( {x}_{i} ) )}^{T} \vert}{\sqrt{( {\sum }_{i = 1}^{N} {‖ h ( {x}_{i} ) ‖}^{2} )}} \\ = {argmax}_{h} ɛ ( h )\end{matrix}$$

5b) output: F(x)=J(g(x),k(x)):R^{d}→R^{2q}

When k(x) is converged, the value of M(k(x)) is minimized, and the corresponding mapping function F(x) at this time is the pose classifier.

The process of calculating k(x) is a regression process, and in each regression, the optimal weak mapping function hₜ(x) is acquired from the mapping function pool.

After said pose classifier is generated, it can be stored for later use. Specifically, the pose classifier generated in the present embodiment can also be used for the pose estimation in the subsequent process of training the object classifier and the process of object detection.

In the present embodiment, the process of executing a regression training process according to said specified number of training image samples and the actual pose information thereof is specifically realized by the realization processes of S203 and S205 to generate the pose classifier.

In the present embodiment, a first training image sample set and the actual pose information of a specified number of training image samples in said first training image sample set are acquired, a mapping function and a loss function are constructed according to said specified number of training image samples and the actual pose information thereof, said mapping function is adjusted according to the output value of said loss function until the output value of said loss function is minimal, and the mapping function which minimizes the output value of said loss function is selected as the pose classifier by realizing regression training process, such that the objects with joints in various poses can be detected by the pose classifier, thereby the object hit rate is increased.

In addition, the pose classifier generated by the regression method is output to the object classifier training process and the object detection process respectively for pose estimation, which means that the method of multi-output regression is adopted in the present embodiment, and computation complexity of the method in the present embodiment is reduced compared with that of traditional pose estimation methods. In the present embodiment, direction difference is considered when the loss function is constructed, which is more advantageous for detecting objects in different poses and increases the object hit rate.

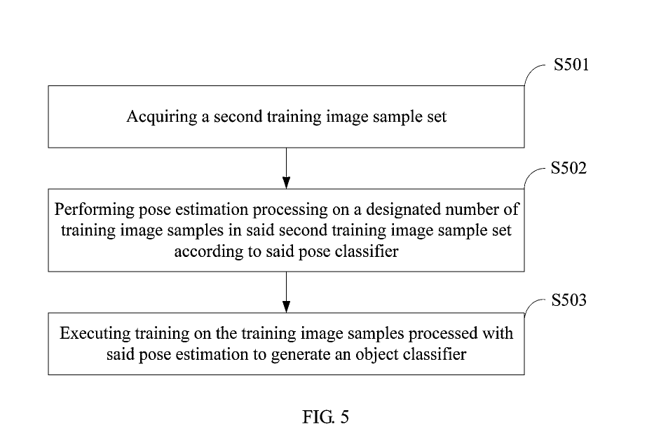

Referring to FIG. 5, a flow chart of an embodiment of a method for training an object classifier is provided in the embodiment of the present invention. Said objects are objects with joints, including but not limited to objects such as human bodies, robots, monkeys or dogs, etc.; in the present embodiment, the pose classifier adopted in the present embodiment is the one generated in the above mentioned embodiment.

Said method for training an object classifier comprises:

S501: Acquiring a second training image sample set.

S502: Performing pose estimation processing on a specified number of training image samples in said second training image sample set according to said pose classifier.

S503: Executing training on the training image samples processed with said pose estimation to generate an object classifier.

In the present embodiment, pose estimation processing on a specified number of training image samples in the second training image sample set is performed according to the pose classifier, then the training image samples processed with said pose estimation processing are trained to generate the object classifier, therefore the impact of the pose on the calculation of object features are eliminated by the generated object classifier, such that the same type of objects can have consistent feature vectors even in different poses, thereby objects with joints in different poses can be detected and object hit rate can be increased.

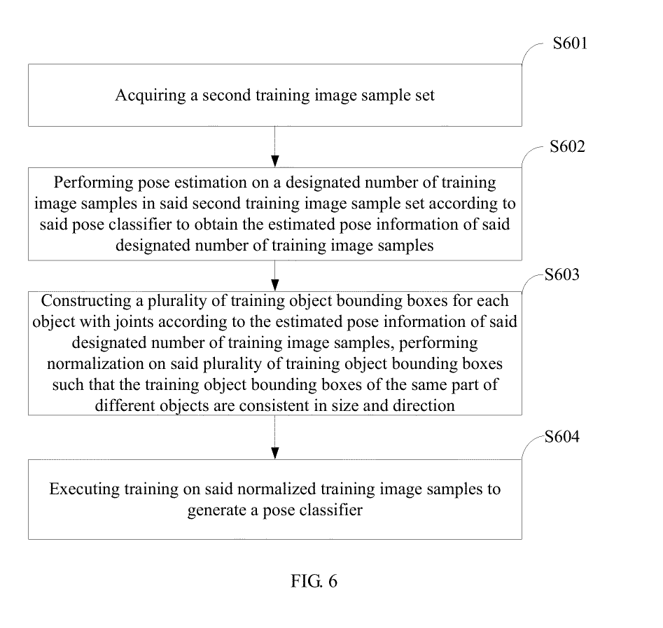

The objects in the embodiment of the present invention are specifically objects with joints, including but not limited to objects such as human bodies, robots, monkeys or dogs, etc. In the present embodiment, human bodies are used as an example for detailed description. Referring to FIG. 6, a flow chart of another embodiment of the method for training an object classifier is provided in the embodiment of the present invention, and the pose classifier adopted in the present embodiment is the pose classifier generated in the above mentioned embodiment.

Said method for training an object classifier comprises:

S601: Acquiring a second training image sample set.

During the process of training the object classifier, a plurality of image samples shall be used as training image samples to execute the training process. Specifically, said plurality of image samples can be pieces of images of objects with joints, such as human bodies, or other objects. In the embodiment of the present invention, the plurality of training image samples can be stored as a second training image sample set.

All the training image samples in said second training image sample can be acquired by the image collecting device(s) at the same scene or different scenes.

602: Performing pose estimation on a specified number of training image samples in said second training image sample set according to said pose classifier to obtain the estimated pose information of said specified number of training image samples.

Said specified number of training image samples can be all the training image samples in said second training image sample set, or part of the training image samples in said second training image sample set. Preferably, said specified number of training image samples refer to all the training image samples in said second training image sample set, such that the accuracy of the generated object classifier is improved.

In the embodiment of the present invention, the related estimated pose information refers to the estimated location information of each part of the human body, specifically, the location information of structural feature points of a training human body. Said structural feature points of the training human body may be one or more points, preferably, there may be four or six structural feature points of the human body. Specifically, in the case that there are four structural feature points of the human body, said structural feature points of the human body include: a head central point, waist central point, left foot central point, and right foot central point; in the case that there are six structural feature points of the human body, said structural feature points of the human body include: a head central point, waist central point, left knee central point, right knee central point, left foot central point, and right foot central point.

In another embodiment, after the estimated pose information of said specified training image samples is obtained, the estimated pose information of said specified number of training image samples, specifically, the location information of the structural feature points of the human body of said specified training image samples can also be displayed.

S603: Constructing a plurality of training object bounding boxes for each object with joints according to the estimated pose information of said specified number of training image samples, performing normalization on said plurality of training object bounding boxes such that the training object bounding boxes of the same part of different objects are consistent in size and direction.

In this step, said estimated pose information specifically is the location information of the structural feature points of human body, then a plurality of training human body bounding boxes are constructed for each human body according to said location information of the structural feature points of human body; preferably but not limited, the waist central point is used as a root node to construct the human body bounding box.

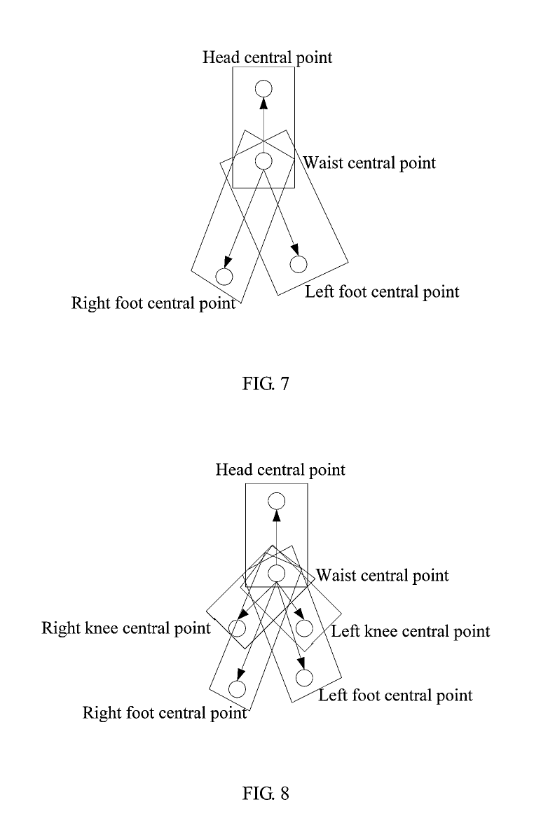

Specifically, when there are four structural feature points of the training human body, three human body bounding boxes are constructed respectively for each human body by taking the straight line between the head central point and waist central point as the central axis, the straight line between the waist central point and the left foot central point as the central axis, and the straight line between the waist central point and the right foot central point as the central axis, as shown in FIG. 7, the schematic diagram of the human body bounding boxes of four feature points is provided in the embodiment of the present invention.

After being constructed, said three human body bounding boxes are rotated and resized, namely normalized, such that the human body bounding boxes of the same part of different human bodies are consistent in size and direction, wherein said structural feature points of human body are located in the corresponding human body bounding boxes.

In another embodiment, when there are six training structural feature points of human body, five human body bounding boxes are constructed respectively for each human body by taking the straight line between the head central point and the waist central point as the central axis, the straight line between the waist central point and the left knee central point as the central axis, the straight line between the waist central point and the right knee central point as the central axis, the straight line between the waist central point and the left foot central point as the central axis, and the straight line between the waist central point and the right foot central point as the central axis, as shown in FIG. 8. FIG. 8 illustrates the schematic diagram of the human body bounding boxes of six feature points provided in the embodiment of the present invention.

After being constructed, said five human body bounding boxes are rotated and resized, namely normalized, such that the human body bounding boxes of the same part of different human bodies are consistent in size and direction, wherein said structural feature points of human body are located in the corresponding human body bounding boxes.

In the present embodiment, the process of performing pose estimation processing on the specified number of training image samples in said second training image sample set according to said pose classifier is specifically realized by the realization processes of S602 and S603.

In another embodiment, after performing normalization on the plurality of training object bounding boxes, said plurality normalized training object bounding boxes, specifically the plurality of rotated and resized training object bounding boxes, can be displayed, as shown in FIG. 7 and FIG. 8.

S604: Executing training on said normalized training image samples to generate a pose classifier.

In this step, said executing training on the normalized training image samples specifically comprises: computing the feature vectors of the human body bounding boxes of the normalized training image samples, training said feature vectors, such that the impact of the pose of human body on the feature computation is eliminated, and thus the same type of objects can have consistent feature vectors even in different poses, wherein said feature vectors are HOG vectors.

Preferably, said object classifier includes SVM (Support Vector Machine) object classifier, specifically is, but not limited to SVM human classifiers.

Optionally, after the feature vectors of the human body bounding boxes of the normalized training image samples are computed, said feature vectors can be stored for later use. Specifically, the object classifier generated in the present embodiment may be used for objection detection in the subsequent object detection process.

Preferably, after said SVM object classifier is obtained, it can be stored for later use.

In the present embodiment, pose estimation processing on a specified number of training image samples in the second training image sample set is performed according to the pose classifier, then the training image samples processed with said pose estimation processing are trained to generate the object classifier. Therefore the impact of the pose on the calculation of object features are eliminated by the generated object classifier, such that the same type of objects can have consistent feature vectors even in different poses, thereby objects with joints in different poses can be detected and object hit rate can be increased.

Referring to FIG. 9, a flow chart of an embodiment of a method for object detection is provided in the embodiment of the present invention. The objects in the embodiments of the present invention specifically are objects with joints, including but not limited to objects such as human bodies, robots, monkeys or dogs etc. The pose classifier and object classifier adopted in the present embodiment are the pose classifier and object classifier generated in the above mentioned embodiments.

Said method for object detection comprises:

S901: Acquiring input image samples.

S902: Performing pose estimation processing on said input image samples according to said pose classifier.

S903: Performing object detection on the processed input image samples according to said object classifier to acquire the location information of the object.

In the present embodiment, pose estimation processing on the input image samples is performed according to the pose classifier, thus the impact of the pose on feature computation is eliminated, such that the same type of objects can have consistent feature vectors even in different poses; then object detection is performed on the processed input image samples using the object classifier generated according to pose estimation, therefore the location information of the objects is obtained, the pose information of the objects is fully considered in the object detection process, and the objects with joints in different poses can be detected, thus the object hit rate is increased.

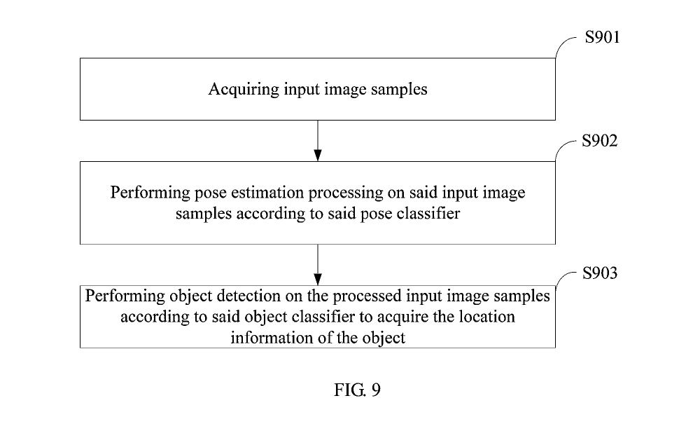

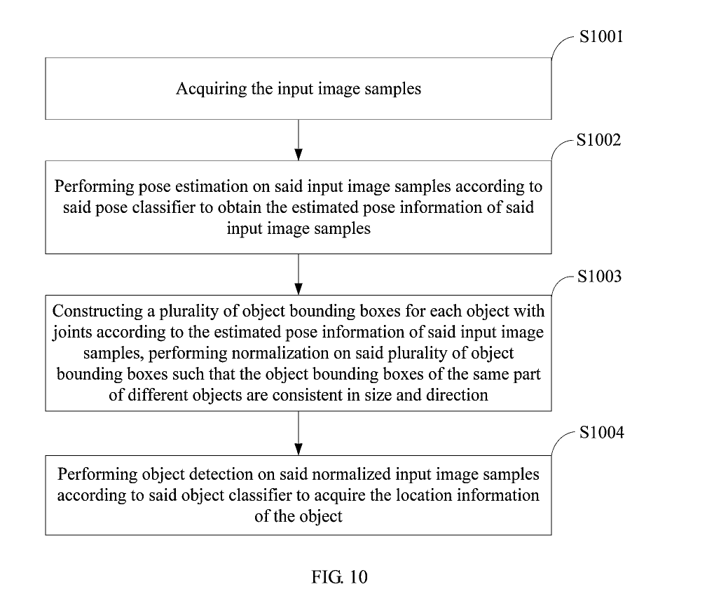

The objects in the embodiments of the present invention specifically are objects with joints, including but not limited to objects such as human bodies, robots, monkeys or dogs, etc. In the present embodiment, human bodies are used as an example for detailed description. FIG. 10 is a flow chart of another embodiment of method for object detection provided in the embodiment of the present invention; and the pose classifier and object classifier adopted in the present embodiment are the pose classifier and object classifier generated in the above mentioned embodiments.

S1001: Acquiring the input image samples.

During the process of object detection, detection is required on the input image samples to detect if there are objects with joints such as a human body in said input image samples. Said input image sample may be a piece of a picture which may include one or more human bodies, or which may not include human bodies, there is no specific limitation in this aspect.

S1002: Performing pose estimation on said input image samples according to said pose classifier to obtain the estimated pose information of said input image samples.

Said estimated pose information specifically is the location information of the structural feature points of the human body. Preferably, there may be four or six structural feature points of human body. Specifically, in the case that there are four structural feature points of the human body, said structural feature points of the human body include: a head central point, waist central point, left foot central point, and right foot central point; in the case that there are six structural feature points of the human body, said structural feature points of the human body include: a head central point, waist central point, left knee central point, right knee central point, left foot central point, and right foot central point.

S1003: Constructing a plurality of object bounding boxes for each object with joints according to the estimated pose information of said input image samples, performing normalization on said plurality of object bounding boxes such that the object bounding boxes of the same part of different objects are consistent in size and direction.

The procedures of S1003 and S603 are similar. The difference is that in S603, the corresponding processing is carried out according to the estimated pose information of the specified image samples in said second training image samples, while in S1003, the corresponding processing is carried out on the estimated pose information of said input image samples. Related description can be found in S603 and will not be described in detail here.

In the present embodiment, the process of performing pose estimation processing on said input image samples according to said pose classifier is specifically realized in the realization processes of S1002 and S1003.

S1004: Performing object detection on said normalized input image samples according to said object classifier to acquire the location information of the object.

In this step, said performing human body detection on said normalized input image samples according to said object classifier specifically comprises: computing the feature vectors of the normalized human body bounding boxes of the input image samples, performing human body detection on said feature vectors of the normalized human body bounding boxes of the input image samples according to said object classifier, specifically, the human body classifier to eliminate the influences of the poses of human body on the feature computation such that the same type of objects have consistent feature vectors even in different poses, wherein said feature vectors are HOG vectors.

ROC (Receiver Operating Characteristic) curve reflects the relationship between the hit rate and false positive rate of the system, wherein the hit rate=quantity of the correctively detected target objects/the total quantity of the target objects in the test set; the false positive rate=quantity of the falsely detected target objects/the total quantity of all scanning windows in the test set. See FIG. 11 for the ROC curve of the method for object detection in the present embodiment. FIG. 11 is the ROC curve of the embodiments of the present invention (ROC Curve 2) and the prior art (ROC Curve 1). It can be seen from FIG. 11 that the ROC curve of the method for object detection in the embodiment of the present invention is obviously superior to that of the prior art.

In the present embodiment, pose estimation processing on the input image samples is performed according to the pose classifier, thus the impact of the pose on feature computation is eliminated, such that the same type of objects can have consistent feature vectors even in different poses; then object detection is performed on the processed input image samples using the object classifier generated according to pose estimation, therefore the location information of the objects is obtained, the pose information of the objects with joints is fully considered in the object detection process, and the objects with joints in different poses can be detected, thus the object hit rate is increased.

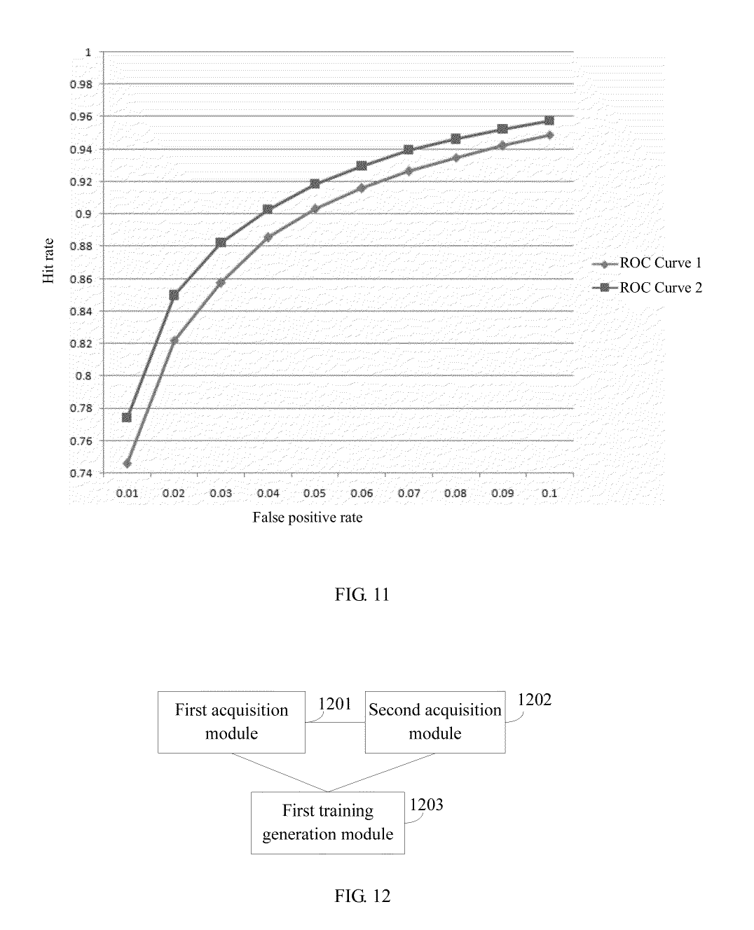

FIG. 12 is a structural diagram of a device for training a pose classifier provided in the embodiment of the present invention. Said device for training a pose classifier comprises:

a first acquisition module 1201 for acquiring a first training image sample set;

a second acquisition module 1202 for acquiring the actual pose information of a specified number of training image samples in said first training image sample set; and

a first training generation module 1203 for executing a regression training process according to said specified number of training image samples and the actual pose information thereof to generate a pose classifier.

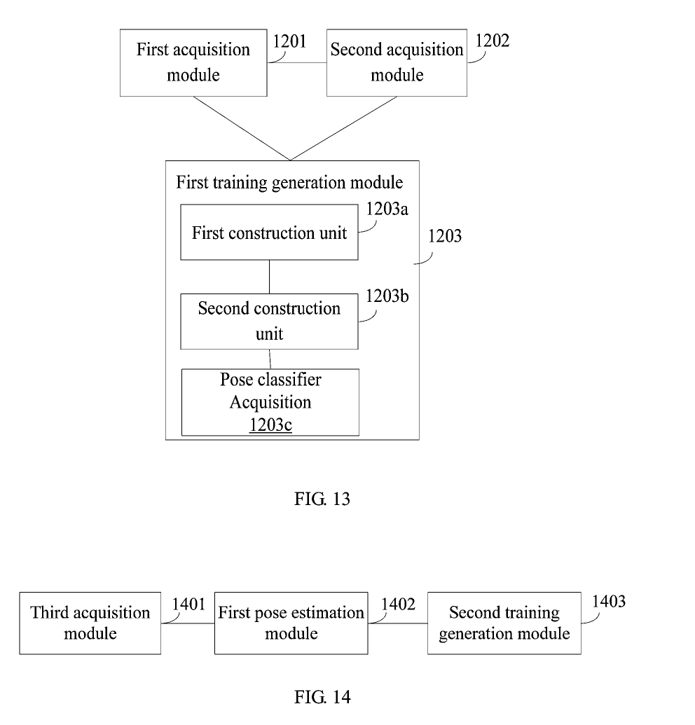

Referring to FIG. 13, in one embodiment, said first training generation module 1203 comprises:

a first construction unit 1203a for constructing a loss function, wherein the input of said loss function is said specified number of training image samples and the actual pose information thereof, the output of said loss function is difference between the actual pose information and the estimated pose information of said specified number of training image samples;

a second construction unit 1203b for constructing a mapping function, wherein the input of said mapping function is said specified number of training image samples, the output of said mapping function is the estimated pose information of said specified number of training image samples;

and a pose classifier acquisition unit 1203c for executing regression according to said specified number of training image samples and the actual pose information thereof, selecting the mapping function which minimizes the output value of said loss function as the pose classifier.

Wherein, said loss function is the location difference between the actual pose information and the estimated pose information.

Or, said loss function is the location difference and direction difference between the actual pose information and the estimated pose information.

In the present embodiment, a first training image sample set and the actual pose information of a specified number of training image samples in said first training image sample set are acquired, a mapping function and a loss function are constructed according to said specified number of training image samples and the actual pose information thereof, said mapping function is adjusted according to the output value of said loss function until the output value of said loss function is minimal, and the mapping function which minimizes the output value of said loss function is selected as the pose classifier by realizing regression training process, such that the objects with joints in various poses can be detected by the pose classifier, thereby the object hit rate is increased.

In addition, the pose classifier generated by regression method is output to the object classifier training process and the object detection process respectively for pose estimation, which means that the method of multi-output regression is adopted in the present embodiment, and computation complexity of the method in the present embodiment is reduced comparing with that of traditional pose estimation method. In the present embodiment, direction difference is considered when the loss function is constructed, which is more advantageous for detecting objects in different poses and increases the object hit rate.

The objects in the embodiment of the present invention are specifically objects with joints, including but not limited to objects such as human bodies, robots, monkeys or dogs, etc. FIG. 14 is a structural diagram of an embodiment of the device for training an object classifier provided in the embodiment of the present invention. Said device for training an object classifier in the present embodiment is the pose classifier generated in the above mentioned embodiment.

Said device for training an object classifier comprises:

a third acquisition module 1401 for acquiring a second training image sample set;

a first pose estimation module 1402 for performing pose estimation processing on a specified number of training image samples in said second training image sample set according to said pose classifier; and

a second training generation module 1403 for executing training on the training image samples processed with said pose estimation to generate an object classifier.

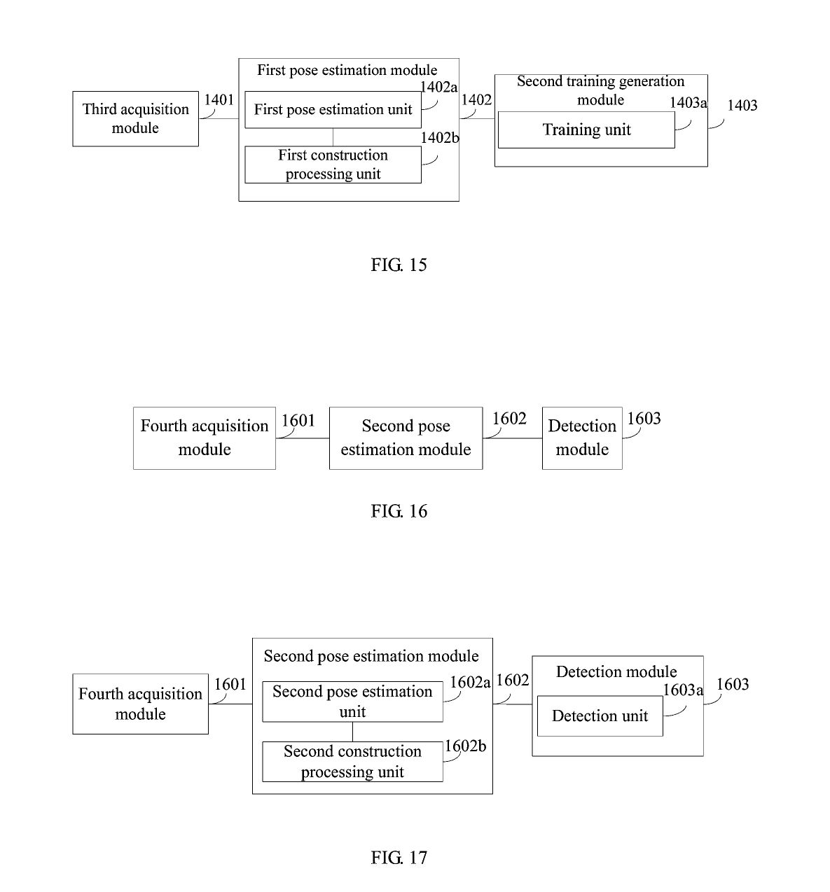

Referring to FIG. 15, in one embodiment, said first pose estimation module 1402 comprises:

a first pose estimation unit 1402a for performing pose estimation on a specified number of training image samples in said second training image sample set according to said pose classifier to obtain the estimated pose information of said specified number of training image samples.

a first construction processing unit 1402b for constructing a plurality of training object bounding boxes for each object with joints according to the estimated pose information of said specified number of training image samples, performing normalization on said plurality of training object bounding boxes such that the training object bounding boxes of the same part of different objects are consistent in size and direction.

Correspondingly, said second training generation module 1403 comprises:

a training unit 1403a for executing training on said normalized training image samples.

In another embodiment, said device further comprises:

a first graphic user interface (GUI) for displaying the estimated pose information of said specified number of training image samples after said obtaining the estimated pose information of said specified number of training image samples.

In another embodiment, said device further comprises:

a second graphic user interface for displaying said plurality of normalized training object bounding boxes after said performing normalization on said plurality of training object bounding boxes.

In another embodiment, said estimated pose information specifically is the location information of the structural feature points of training object, said structural feature points of training object comprise: a head central point, waist central point, left foot central point, and right foot central point;

said first construction processing unit 1402b comprises:

a first construction sub-unit for constructing three object bounding boxes for each object with joints by respectively taking the straight line between the head central point and the waist central point as the central axis, the straight line between the waist central point and the left foot central point as the central axis, and the straight line between the waist central point and the right foot central point as the central axis, rotating and resizing said three object bounding boxes; wherein said structural feature points of object are located in the corresponding object bounding boxes.

In another embodiment, said estimated pose information specifically is the location information of the structural feature points of training object, said structural feature points of training object comprise: a head central point, waist central point, left knee central point, right knee central point, left foot central point, and right foot central point;

said first construction processing unit 1402b comprises:

a second construction sub-unit for constructing five object bounding boxes for each object with joints by respectively taking the straight line between the head central point and the waist central point as the central axis, the straight line between the waist central point and the left knee central point as the central axis, the straight line between the waist central point and the right knee central point as the central axis, the straight line between the waist central point and the left foot central point as the central axis, and the straight line between the waist central point and the right foot central point as the central axis, rotating and resizing said five object bounding boxes; wherein said structural feature points of object are located in the corresponding object bounding boxes.

In the present embodiment, pose estimation processing on a specified number of training image samples in the second training image sample set is performed according to the pose classifier, then the training image samples processed with said pose estimation processing are trained to generate the object classifier. Therefore, the impact of the pose on the calculation of object features is eliminated by the generated object classifier such that the same type of objects can have consistent feature vectors even in different poses; thereby objects with joints in different poses can be detected and object hit rate can be increased.

The objects in the embodiment of the present invention are objects with joints, including but not limited to objects such as human bodies, robots, monkeys or dogs, etc. FIG. 16 is a structural diagram of an embodiment of the device for object detection provided in the embodiment of the present invention. Said device for object detection in the present embodiment adopts the pose classifier and object classifier generated in the above mentioned embodiments.

Said device for object detection comprises:

a fourth acquisition module 1601 for acquiring input image samples;

a second pose estimation module 1602 for performing pose estimation processing on said input image samples according to said pose classifier; and

a detection module 1603 for performing objects detection on the processed input image samples according to said object classifier to acquire the location information of the object.

Referring to FIG. 17, in one embodiment, said second pose estimation module 1602 comprises:

a second pose estimation unit 1602a for performing pose estimation on said input image samples according to said pose classifier to obtain the estimated pose information of said input image samples; and

a second construction processing unit 1602b for constructing a plurality of object bounding boxes for each object with joints according to the estimated pose information of said input image samples, performing normalization on said plurality of object bounding boxes such that the training object bounding boxes of the same part of different objects are consistent in size and direction.

Correspondingly, said detection module 1603 comprises:

a detection unit 1603a for performing object detection on said normalized input image samples according to said object classifier.

In another embodiment, said device further comprises:

a third graphic user interface for displaying the estimated pose information of said input image samples after said obtaining the estimated pose information of said input image samples.

In another embodiment, said device further comprises:

a fourth graphic user interface for displaying said plurality of normalized object bounding boxes after said performing normalization on the plurality of object bounding boxes.

In other embodiment, said estimated pose information specifically is the location information of the structural feature points of object, said structural feature points of object comprise: a head central point, waist central point, left foot central point, and right foot central point.

said second construction processing unit 1602b comprises:

a third construction sub-unit for constructing three object bounding boxes for each object with joints by respectively taking the straight line between the head central point and the waist central point as the central axis, the straight line between the waist central point and the left foot central point as the central axis, and the straight line between the waist central point and the right foot central point as the central axis, rotating and resizing said three object bounding boxes; wherein said structural feature points of object are located in the corresponding object bounding boxes.

In other embodiment, said estimated pose information specifically is the location information of the structural feature points of object, said structural feature points of object comprise: a head central point, waist central point, left knee central point, right knee central point, left foot central point, and right foot central point;

said second construction processing unit 1602b comprises:

a fourth construction sub-unit for constructing five object bounding boxes for each object with joints by taking the straight line between the head central point and the waist central point as the central axis, the straight line between the waist central point and the left knee central point as the central axis, the straight line between the waist central point and the right knee central point as the central axis, the straight line between the waist central point and the left foot central point as the central axis, and the straight line between the waist central point and the right foot central point as the central axis, rotating and resizing said five object bounding boxes; wherein said structural feature points of said object are located in the corresponding object bounding boxes.

In the present embodiment, pose estimation processing on the input image samples is performed according to the pose classifier, thus the impact of the pose on feature computation is eliminated, such that the same type of objects can have consistent feature vectors even in different poses; then object detection is performed on the processed input image samples using the object classifier generated according to pose estimation, therefore the location information of the objects is obtained. The pose information of the objects is fully considered in the object detection process, and the objects with joints in different poses can be detected, thus the object hit rate is increased.

It should be noted that, all embodiments of the description are described in a progressive means, each embodiment highlights the differences with other embodiments and the same part of the embodiments shall refer to each other. Since the embodiments of devices are basically similar with the embodiments of methods, they are simply described. See part of the descriptions of the embodiments of methods for the relevance.

It should be noted that in the present content, the relation terminologies such as the first and the second are only used for distinguishing one entity or operation from another entity or operation, but do not require or imply any real relation or sequence of those entities or operation. Moreover, the terminologies “comprising”, “including”, and any other variant are intended to cover the non-exclusive inclusion such that processes, methods, objects, or devices (including a series of requirements) not only include such factors, but also include those clearly listed, or also include inherent factors of the processes, methods, objects, or devices. On conditions of no more limitation, the factors limited by the sentence “comprising a . . . ” do not exclude other identical factors existing in the processes, methods, objects, or devices.

Those ordinarily skilled in this field can understand that all or part of the steps for realizing the above mentioned embodiments can be completed by hardware or by the related hardware under the direction of a program; said program can be stored in a readable memory media which may be a ROM, a disc or an optical disc.

The above mentioned descriptions are exemplary embodiments of the present invention, which cannot limit the present invention. Within the spirit and principle of the present invention, any modification, equivalent substitution or improvement all shall be included in the protection scope of the present invention.

What is claimed is:

1. A method for training a pose classifier, comprising:
acquiring a first training image sample set;
acquiring actual pose information of a specified number of training image samples in said first training image sample set; and
executing a regression training process according to said specified number of training image samples and the actual pose information thereof to generate a pose classifier.

2. The method according to claim 1, wherein said executing a regression training process according to said specified number of training image samples and the actual pose information thereof to generate a pose classifier comprises:
constructing a loss function, wherein an input of said loss function is said specified number of training image samples and the actual pose information thereof, an output of said loss function is a difference between the actual pose information and estimated pose information of said specified number of training image samples;
constructing a mapping function, wherein an input of said mapping function is said specified number of training image samples, an output of said mapping function is the estimated pose information of said specified number of training image samples; and
executing regression according to said specified number of training image samples and the actual pose information thereof, selecting a mapping function which minimizes an output value of said loss function as the pose classifier.

3. The method according to claim 2, wherein said loss function is a location difference between the actual pose information and the estimated pose information.

4. The method according to claim 2, wherein said loss function is a location difference and direction difference between the actual pose information and the estimated pose information.

5. A method for training an object classifier using the pose classifier generated by the method according to claim 1, wherein said object is an object with joints, said method comprising:
acquiring a second training image sample set;
performing pose estimation processing on a specified number of training image samples in said second training image sample set according to said pose classifier; and
executing training on the training image samples processed with said pose estimation to generate an object classifier.

6. The method according to claim 5, wherein said performing pose estimation processing on a specified number of training image samples in said second training image sample set according to said pose classifier comprises:
performing pose estimation on a specified number of training image samples in said second training image sample set according to said pose classifier to obtain the estimated pose information of said specified number of training image samples; and
constructing a plurality of training object bounding boxes for each object with joints according to the estimated pose information of said specified number of training image samples, performing normalization on said plurality of training object bounding boxes such that the training object bounding boxes of a same part of different objects are consistent in size and direction;
said executing training on the training image samples processed with said pose estimation further comprises:
executing training on said normalized training image samples.

7. The method according to claim 6, wherein after said obtaining the estimated pose information of said specified number of training image samples, the method further comprises:
displaying the estimated pose information of said specified number of training image samples.

8. The method according to claim 6, wherein after said performing normalization on said plurality of training object bounding boxes, the method further comprises:
displaying said plurality of normalized training object bounding boxes.

9. The method according to claim 5, wherein said estimated pose information includes location information of the structural feature points of the training object, said structural feature points of the training object comprising:
a head central point, a waist central point, a left foot central point, and a right foot central point;
said constructing a plurality of object bounding boxes for each object with joints according to the estimated pose information of said specified number of training image samples, performing normalization on said plurality of object bounding boxes comprises:
constructing three object bounding boxes for each object with joints by respectively taking a straight line between the head central point and the waist central point as a central axis, the straight line between the waist central point and the left foot central point as a central axis, and the straight line between the waist central point and the right foot central point as a central axis, rotating and resizing said three object bounding boxes; wherein said structural feature points of the object are located in the corresponding object bounding boxes.

10. The method according to claim 5, wherein said estimated pose information includes location information of the structural feature points of the training object, said structural feature points of the training object comprising:
a head central point, a waist central point, a left knee central point, a right knee central point, a left foot central point, and a right foot central point;
said constructing a plurality of object bounding boxes for each object with joints according to the estimated pose information of said specified number of training image samples, performing normalization on said plurality of training object bounding boxes comprises:
constructing five object bounding boxes for each object with joints by respectively taking a straight line between the head central point and the waist central point as a central axis, the straight line between the waist central point and the left knee central point as a central axis, the straight line between the waist central point and the right knee central point as a central axis, the straight line between the waist central point and the left foot central point as a central axis, and the straight line between the waist central point and the right foot central point as a central axis, rotating and resizing said five object bounding boxes; wherein said structural feature points of object are located in the corresponding object bounding boxes.

11. A method for object detection using the pose classifier generated by the method according to claim 1 and an object classifier wherein an object is an object with joints, comprising:
acquiring input image samples;
performing pose estimation processing on said input image samples according to said pose classifier; and
performing object detection on the processed input image samples according to said object classifier to acquire the location information of the object.

12. The method according to claim 11, wherein said performing pose estimation processing on said input image samples according to said pose classifier comprises:
performing pose estimation on said input image samples according to said pose classifier to obtain the estimated pose information of said input image samples; and
constructing a plurality of object bounding boxes for each object with joints according to the estimated pose information of said input image samples, performing normalization on said plurality of object bounding boxes such that the object bounding boxes of the same part of different objects are consistent in size and direction;
correspondingly, said performing object detection on the processed input image samples according to said object classifier comprises:
performing object detection on said normalized input image samples according to said object classifier.

13. The method according to claim 12, wherein after said obtaining the estimated pose information of said input image samples, further comprising:
displaying the estimated pose information of said input image samples.

14. The method according to claim 12, wherein after said performing normalization on the plurality of object bounding boxes, further comprising:
displaying said plurality of normalized object bounding boxes.

15. The method according to claim 12, wherein said estimated pose information includes location information of the structural feature points of an object, said structural feature points of the object comprise:
a head central point, a waist central point, a left foot central point, and a right foot central point;
said constructing a plurality of object bounding boxes for each object with joints according to the estimated pose information of said input image samples, performing normalization on said plurality of object bounding boxes comprising:
constructing three object bounding boxes for each object with joints by respectively taking a straight line between the head central point and the waist central point as a central axis, the straight line between the waist central point and the left foot central point as a central axis, and the straight line between the waist central point and the right foot central point as a central axis, rotating and resizing said three object bounding boxes; wherein said structural feature points of object are located in the corresponding object bounding boxes.

16. The method according to claim 12, wherein said estimated pose information specifically includes location information of the structural feature points of an object, said structural feature points of the object comprise:
a head central point, a waist central point, a left knee central point, a right knee central point, a left foot central point, and a right foot central point;
said constructing a plurality of object bounding boxes for each object with joints according to the estimated pose information of said input image samples, performing normalization on said plurality of object bounding boxes comprising:
constructing five object bounding boxes for each object with joints by respectively taking a straight line between the head central point and the waist central point as a central axis, the straight line between the waist central point and the left knee central point as a central axis, the straight line between the waist central point and the right knee central point as a central axis, the straight line between the waist central point and the left foot central point as a central axis, and the straight line between the waist central point and the right foot central point as a central axis, rotating and resizing said five object bounding boxes; wherein said structural feature points of said object are located in the corresponding object bounding boxes.

17. A device for training a pose classifier and stored in computer readable storage media, comprising:
a first acquisition module for acquiring a first training image sample set;
a second acquisition module for acquiring the actual pose information of a specified number of training image samples in said first training image sample set; and
a first training generation module for executing a regression training process according to said specified number of training image samples and the actual pose information thereof to generate a pose classifier.

18. The device according to claim 17, wherein said first training generation module comprises:
a first construction unit for constructing a loss function, wherein an input of said loss function is said specified number of training image samples and the actual pose information thereof, an output of said loss function is a difference between the actual pose information and the estimated pose information of said specified number of training image samples;
a second construction unit for constructing a mapping function, wherein an input of said mapping function is said specified number of training image samples, an output of said mapping function is the estimated pose information of said specified number of training image samples; and
a pose classifier acquisition unit for executing regression according to said specified number of training image samples and the actual pose information thereof, and for selecting the mapping function which minimizes an output value of said loss function as the pose classifier.

19. The device according to claim 18, wherein said loss function includes at least one of a location difference between the actual pose information and the estimated pose information or a location difference and direction difference between the actual pose information and the estimated pose information.

20. A device for training an object classifier using the pose classifier generated by the device according to claim 17, wherein said object is an object with joints, said device comprising:
a third acquisition module for acquiring a second training image sample set;
a first pose estimation module for performing pose estimation processing on a specified number of training image samples in said second training image sample set according to said pose classifier; and
a second training generation module for executing training on the training image samples processed with said pose estimation to generate an object classifier.

21. The device according to claim 20, wherein said first pose estimation module comprises:
a first pose estimation unit for performing pose estimation on a specified number of training image samples in said second training image sample set according to said pose classifier to obtain the estimated pose information of said specified number of training image samples; and
a first construction processing unit for constructing a plurality of training object bounding boxes for each object with joints according to the estimated pose information of said specified number of training image samples, performing normalization on said plurality of training object bounding boxes such that the training object bounding boxes of the same part of different objects are consistent in size and direction;
said second training generation module further comprising:
a training unit for executing training on said normalized training image samples.

22. The device according to claim 21, further comprising:
a first graphic user interface for displaying the estimated pose information of said specified number of training image samples after said obtaining the estimated pose information of said specified number of training image samples.

23. The device according to claim 21, further comprising:
a second graphic user interface for displaying said plurality of normalized training object bounding boxes after said performing normalization on said plurality of training object bounding boxes.

24. The device according to claim 21, wherein said estimated pose information specifically includes location information of the structural feature points of a training object, said structural feature points of the training object comprise:
a head central point, a waist central point, a left foot central point, and a right foot central point;
said first construction processing unit comprises:
a first construction sub-unit for constructing three object bounding boxes for each object with joints by respectively taking a straight line between the head central point and the waist central point as a central axis, the straight line between the waist central point and the left foot central point as a central axis, and the straight line between the waist central point and the right foot central point as a central axis, rotating and resizing said three object bounding boxes; wherein said structural feature points of object are located in the corresponding object bounding boxes.

25. A device for object detection using the pose classifier generated by the device according to claim 17 and an object classifier wherein said object is an object with joints, said device comprising:
a fourth acquisition module for acquiring input image samples;
a second pose estimation module for performing pose estimation processing on said input image samples according to said pose classifier; and
a detection module for performing objects detection on processed input image samples according to said object classifier to acquire the location information of the object.
wherein said second pose estimation module comprises:
a second pose estimation unit for performing pose estimation on said input image samples according to said pose classifier to obtain the estimated pose information of said input image samples;
a second construction processing unit for constructing a plurality of object bounding boxes for each object with joints according to the estimated pose information of said input image samples, performing normalization on said plurality of object bounding boxes such that the training object bounding boxes of the same part of different objects are consistent in size and direction;
said detection module comprises:
a detection unit for performing object detection on said normalized input image samples according to said object classifier;
a third graphic user interface for displaying the estimated pose information of said input image samples after said obtaining the estimated pose information of said input image samples;
a fourth graphic user interface for displaying said plurality of normalized object bounding boxes after said performing normalization on the plurality of object bounding boxes;
said estimated pose information includes location information of the structural feature points of object, said structural feature points of object comprise:
a head central point, a waist central point, a left foot central point, and a right foot central point;
said second construction processing unit comprises:
a third construction sub-unit for constructing three object bounding boxes for each object with joints by respectively taking a straight line between the head central point and the waist central point as a central axis, the straight line between the waist central point and the left foot central point as a central axis, and the straight line between the waist central point and the right foot central point as a central axis, rotating and resizing said three object bounding boxes; wherein said structural feature points of object are located in the corresponding object bounding boxes.
